(19) United States
(12) Patent Application Publication
(10) Pub. No.: US 2008/0317536 A1
(43) Pub. Date: Dec. 25, 2008

(54) Printer apparatus

(75) Inventors: Toru Morikawa, Kanagawa (JP); Shuichi Ota, Saitama (JP); Noboru Koyama, Tokyo (JP); Atsushi Yanbe, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/149,617

(22) Filed: May 6, 2008

(30) Foreign Application Priority Data
Jun. 22, 2007 (JP) 2007-165548

(51) Int. Cl. B41J 2/315

(52) U.S. Cl. 400/120.16

(57) ABSTRACT

A printer apparatus is disclosed. The printer includes: a thermal head having heat generating elements arranged in the form of a line extending longer than the width of a printing medium in the width direction of the printing medium substantially orthogonal to the conveying direction thereof; and a platen disposed opposite to the thermal head with a conveying path for the printing medium interposed between them so as to cooperate with the platen to sandwich the printing medium beyond the width of the printing medium with an ink ribbon interposed. The platen is put in contact with an end portion of the thermal head located beyond the width of the printing medium.

### CROSS REFERENCES TO RELATED APPLICATIONS

The present invention contains subject matter related to Japanese Patent Application JP 2007-165548 filed in the Japanese Patent Office on Jun. 22, 2007, the entire contents of which are incorporated herein by reference.

### BACKGROUND OF THE INVENTION

1. Field of the Invention

The present invention relates to a printer apparatus utilizing a thermal head and, more particularly, to a printer apparatus having measures against the radiation of heat from a thermal head.

2. Description of the Related Art

Thermal head printers for printing utilizing thermal energy generated by energizing heat generating elements have been provided in the related art. Such thermal head printers are primarily categorized into the sublimation type, fusion type, and heat sensitive type printers from the viewpoint of printing methods. A line-type thermal head used in such a thermal head printer includes heat generating elements, such as heat generating resistors and electrodes, arranged in lines in the width direction of the head orthogonal to the direction in which printing paper constituting a printing medium is conveyed. Those heat generating elements of the thermal heads are selectively energized according to image data, and printing is performed on the printing paper by using thermal energy generated at that time.

In a thermal head printer, a platen roller for supporting printing paper is provided opposite to a head section having the head-generating elements of such a thermal head. An ink ribbon having layers of yellow (Y), magenta (M), and cyan (C) dyes and laminate layers is conveyed along with printing paper between the head section and the platen roller. At a printing step, the ink ribbon is heated by putting the thermal head in contact with the ink ribbon while pressing the ink ribbon against the printing paper to thermally transfer the yellow (Y), magenta (M), and cyan (C) dyes and the laminate layers sequentially onto the printing paper.

As shown in FIG. 9, the position of a thermal head 52 of a thermal head printer 50 is fixed relative to printing paper 51. Therefore, a head section 52a is formed with a length greater than the width of the printing paper 51 as a provision for allowing frameless printing and for coping with a shift of the conveying position of the printing paper 51. The head section 52a includes a glass layer, heat generating resistors 53 provided on the glass layer, a pair of electrode groups to be used for power supply and signaling provided on both sides of the heat generating resistors, and a resistor protecting layer provided above and around the heat generating resistors. A plurality of electrodes is formed at very small intervals in the longitudinal direction of the head section 52a to constitute each group of electrodes. A substantially arcuate protrusion is formed on an outer surface of the head section 52a opposite to an ink ribbon 54. The protrusion applies thermal energy of the heat generating resistors 53 to the ink ribbon 54 through the protrusion and provides better contact with the ink ribbon 54.

A platen roller 55 disposed oppositely to the head section 52a having the heat generating resistors 53 provided thereon also has a length greater than the width of the printing paper 51 so as to allow frameless printing and to allow a shift of conveying position of the printing paper to be accommodated.

In such a thermal head printer 50, even heat generating resistors 53 disposed beyond the width of the printing paper 51 are energized to generate thermal energy at a printing step. In the thermal head 52 having the heat generating resistors 53 provided in such positions beyond the width of the printing paper 51, as shown in FIG. 10, the printing paper 51 is not slid, and a gap is formed between the paper and the platen roller 55. As a result, the thermal energy generated is accumulated in the head section 52a instead of being transferred to the printing paper 51.

The printing paper 51 and the ink ribbon 54 must be conveyed at a higher speed to improve the printing speed of the printer, and the amount of heat instantaneously generated per unit area of the thermal head 52 must be increased to obtain thermal energy which is necessary and sufficient for thermal transfer onto the printing paper 51 conveyed at such a high speed. Thus, the amount of heat generated by the heat generating resistors 53 of the thermal head 52 is also increased, which results in an increase in the thermal energy accumulated at the heat generating resistors 53 disposed beyond the width of the printing paper 51, instead of being radiated. Then, the head section 52a is overheated.

When the head section 52a is in such an overheated state, a permanent change can occur in the resistance of the heat generating resistors 53. Further, a grazed glass or the resistor protecting layer on which the heat generating resistors 53 are disposed can be cracked or distorted, and the grazed glass can be melted depending on the temperature of the head in the overheated state. When the head section 52a is damaged as thus described, a printed image may have density irregularities and printing defects, and therefore the head may become unusable.

Approaches proposed in the related art as solutions to the above-described problem include improving the heat resistance of the glass material used for a thermal head, thermal treatment of heat generating resistors to prevent changes in their resistance, and providing thermistors at heat generating resistors disposed in positions beyond the width of printing paper so as to detect any change in the electrical resistance of the resistors and to interrupt the energization of any heat generating resistor at an elevated temperature (JP-A-2004-202827 (Patent Document 1)). Methods proposed for use in thermal head printers, according to the related, art include a method in which a heat radiating member is provided to be urged against a side edge of printing paper under conveyance such that it will contact heat generating resistors in positions beyond the width of the printing paper (JP-A-2003-266751 (Patent Document 2)) and a method in which an end portion of printing paper is read by a sensor to identify heat generating elements to be energized (JP-A-2004-136608 (Patent Document 3)).

However, since each of the methods involves a special configuration to implement it, the methods have not been easy to implement for reasons such as an increase in assembly man-hours, an increased complicatedness of maintenance encountered at the time of paper clogging and at the time of cleaning, and a cost increase.

### SUMMARY OF THE INVENTION

It is desirable to provide a printer apparatus having a simple configuration which allows heat to be radiated from heat generating resistors of a thermal head disposed in positions beyond the width of printing paper so as to prevent damage to the head section and to prevent printing defects.

According to an embodiment of the invention, there is provided a printer apparatus including a thermal head which has heat generating elements arranged in the form of a line extending longer than the width of a printing medium in the width direction of the printing medium substantially orthogonal to the conveying direction of the medium and a platen which is disposed opposite to the thermal head, a conveying path for the printing medium is interposed between them, so as to cooperate with the thermal head to sandwich the printing medium beyond the width of the printing medium with an ink ribbon interposed. The apparatus also is characterized in that the platen is put in contact with an end portion of the thermal head located beyond the width of the printing medium.

In the printer apparatus according to the embodiment of the invention, when the platen sandwiches the printing medium in cooperation with the thermal head, end portions of the thermal head and the platen contact each other in a position beyond the width of the printing medium. Therefore, thermal energy generated at the thermal head of this printer apparatus can be received by the platen to prevent damage attributable to overheating of the thermal head.

### BRIEF DESCRIPTION OF THE DRAWINGS

FIG. 1 is an illustration showing an internal configuration of a printer apparatus according to an embodiment of the invention;

FIG. 2 is a perspective view of a thermal head;

FIG. 3 is a sectional view of the thermal head;

FIG. 4 is a sectional view showing a state of the printer apparatus according to the embodiment of the invention in which printing paper is sandwiched using a platen roller in cooperation with a thermal head;

FIG. 5 is a side view of a platen roller having a thickness gradually increasing toward both end portions thereof;

FIG. 6 is a side view of a platen roller having a thickness increasing stepwise at both end portions thereof;

FIG. 7 is a side view of a platen roller having spacer members provided on both sides thereof;

FIG. 8 is a sectional view of a platen roller having an inner layer portion having relatively high stiffness and an outer layer portion having lower stiffness;

FIG. 9 is a sectional view of a thermal head and a platen roller in a printer apparatus according to the related art; and

FIG. 10 is a sectional view showing a state of the printer apparatus according to the related art in which printing paper is sandwiched between the thermal head and the platen roller.

### DETAILED DESCRIPTION OF THE INVENTION

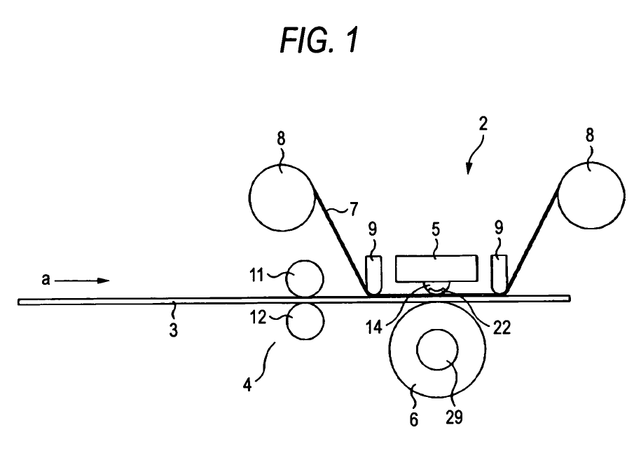

A printer apparatus according to an embodiment of the invention now will be described in detail with reference to the drawings. A printer apparatus 1 is a thermal head printer in which an ink ribbon is put in tight contact with printing paper and in which sublimation dyes applied to the ink ribbon are sublimated and transferred onto the printing paper by thermal energy provided by a thermal head to obtain an image. In such a printer apparatus 1, for example, a sheet of printing paper is pulled out from a tray containing sheets of the printing paper cut in a predetermined size in advance. An image then is formed on the sheet of printing paper thus pulled out, and the sheet is thereafter discharged. Thus, a desired photograph is obtained. As shown in FIG. 1, a conveying mechanism 4 for conveying printing paper 3, a thermal head 5 for forming an image on the printing paper 3, and a platen roller 6 which cooperates with the thermal head 5 to support the printing paper 3 are provided in an apparatus body 2.

In the apparatus body 2, the thermal head 5 and the platen roller 6 are disposed opposite to each other downstream of the printing paper 3 pulled out from the paper tray, which is not shown, when viewed in the conveying direction of the paper. An ink ribbon cartridge is mounted in the apparatus body 2, and the cartridge is guided by a pair of guide members 9, 9 provided before and after the thermal head 5 and the platen roller 6 in parallel with the conveying direction of the printing paper 3 to allow an ink ribbon 7 to be conveyed in tight contact with the printing paper 3.

The conveying mechanism 4 for conveying the printing paper 3 includes a pull-out roller (not shown) for pulling out a sheet of printing paper 3 from the paper tray, a pinch roller 11 and a capstan roller 12 for conveying the printing paper 3 pulled out from the paper tray, and a discharge roller provided downstream of the thermal head 5 when viewed in the conveying direction. To print an image on a sheet of printing paper 3, the conveying mechanism 4 pulls out the printing paper 3 from the paper tray. Then, the sheet is conveyed by the pinch roller 11 and the capstan roller 12 to reciprocate relative to the thermal head 5 such that dye layers of yellow (Y), magenta (M), and cyan (C) and a laminate layer of the ink ribbon will be transferred onto the same location of the sheet 3 having a preset size, with the laminate layer protecting a printed image. When the laminate layer is transferred, the conveying mechanism 4 discharges the sheet of printing paper 3 from the apparatus body 2 with a discharge roller.

The ink ribbon 7 for transferring dyes onto the printing paper 3 has an elongate base material, which is a synthetic resin film such as a polyester film or polystyrene film, dye layers for forming images which are formed by yellow (Y), magenta (M), and cyan (C) dyes and a thermoplastic resin, and a laminate layer which is formed, for example, by the same thermoplastic resin as used in the dye layers. The dye layers and the laminate layer are provided on one side of the base material to sequentially and repeatedly appear in the longitudinal direction at predetermined intervals. Sets of layers each including the dye layers and the laminate layer are sequentially formed on the base material in the longitudinal direction thereof. The dye layers and the laminate layers are thermal-transferred sequentially onto a receiving layer of the printing paper 3 by applying thermal energy to the layers according to image data to be printed with the thermal head 5. One image is printed using dye layers in yellow (Y), magenta (M), and cyan (C) and a laminate layer of such an ink ribbon 7.

The ink ribbon 7 is wound around a pair of spools 8, 8 provided in the ink ribbon cartridge, and the ribbon is supplied sequentially from one spool and taken up by the other spool as printing proceeds. The ink ribbon cartridge containing such an ink ribbon 7 is removably mounted in the apparatus body 2 and replaced with a new one when it is used up. There is no particular limitation on the configuration of the ink ribbon 7 used in the embodiment of the invention, as long as it has at least one dye layer and a laminate layer. For example, the ink ribbon 7 may be formed by a black (K) layer and a laminate layer. Alternatively, the ribbon may be formed by yellow (Y), magenta (M), cyan (C), and black (K) dye layers and a laminate layer.

The printing paper 3 onto which such dye layers and laminate layers are transferred is provided by forming a receiving layer on one side of a base material and forming a backing layer on the other side of the base material.

The base material is provided by forming resin layers on both sides of base paper formed by pulp or the like. The resin layers are made of a thermoplastic resin, such as polyethylene terephthalate or polypropylene, and they have a microvoid structure and cushioning properties. Therefore, the resin layer on the receiving layer side provides improved adhesion and heat insulation between the base paper and the receiving layer and provides an improved property of following up heat from the thermal head 5. The resin layer also provides improved contact with the thermal head 5. Since the receiving layer and the resin layer are made of a thermoplastic resin, they are thermally deformed by thermal energy from the thermal head 5. The layers also are characterized in that they are collapsed by a predetermined pressure applied by the thermal head 5 to lose their cushioning properties.

The receiving layer is a layer which has a thickness of about 1 μm to 10 μm and which receives and holds the dyes transferred from the ink ribbon 7. The layer is formed by a resin, such as an acrylic resin, polyester, polycarbonate, or polyvinyl chloride. The backing layer reduces friction between the printing paper 3 and the capstan roller 12 or platen roller 6 to allow the paper to travel with stability. There is no particular limitation on the configuration of the printing paper 3 as long as it has the receiving layer and the resin layers.

The thermal head 5 for forming an image on such printing paper 3 includes a head section 14 which applies thermal energy to the ink ribbon. The head section 14 is securely disposed in the apparatus body 2 so as to extend in a direction substantially orthogonal to the direction in which the printing paper 3 is conveyed.

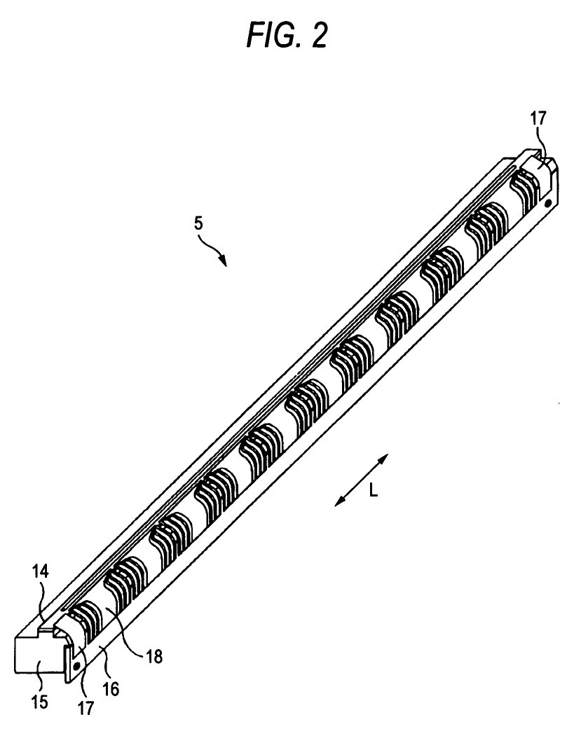

As shown in FIG. 2, the thermal head 5 includes the head section 14 for applying thermal energy to the ink ribbon 7, a radiation member 15 for radiating heat from the head section 14, a rigid substrate 16 carrying a control circuit for controlling the driving of the head section 14, and a flexible substrate 17 for supplying power and a flexible substrate 18 for signaling which electrically connect the head section 14 and the rigid substrate 16.

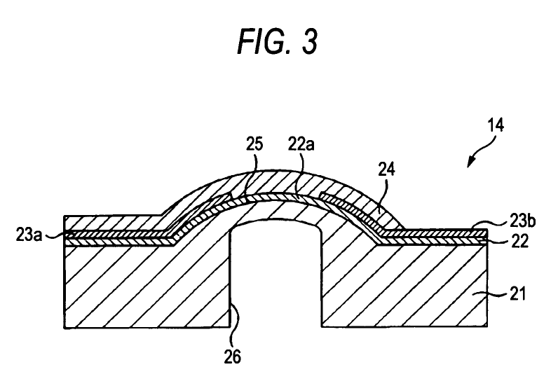

Referring to FIG. 3, the head section 14 includes a glass layer 21, a heat generating resistor 22 provided on the glass layer 21, a pair of electrodes 23a, 23b provided on both sides of the heat generating resistor 22, and a resistor protecting layer 24 provided on the heat generating resistor 22 and around the heat generating resistor 22. The heat generating resistor 22 exposed between the pair of electrodes 23a, 23b constitutes a heat generating part 22a of the thermal head 5. The glass layer 21 has the heat generating resistor 22, the pair of electrodes 23a, 23b, and the resistor protecting layer 24 formed on a top surface thereof, and the layer serves as a base layer of the head section 14.

As shown in FIG. 3, the glass layer 21 has a protrusion 25 on an outer surface thereof facing the ink ribbon 7 and a groove 26 on an inner surface thereof which is mated with the radiation member 15. For example, the glass layer 21 is formed by glass having a softening point of about 500° C. The substantially arcuate protrusion 25 is provided on the outer surface of the glass layer 21 facing the ink ribbon 7 to provide improved contact between the thermal head 5 and the ink ribbon 7 when the head heats the ink ribbon 7. As a result, thermal energy from the heat generating part 22a of the thermal head 5 can be adequately applied to the ink ribbon 7 through the protrusion 25.

The glass layer 21 may be any of the materials represented by glass which has predetermined surface properties and thermal characteristics. The concept of glass includes synthetic jewels and stones, such as artificial crystals, artificial rubies, and artificial sapphires, and high density ceramics.

The groove 26 is provided in a position on the inner surface of the glass layer 21 opposite to the protrusion 25, and it is in the form of a recess extending toward the heat generating part 22a. The groove 26 is formed to extend in the longitudinal direction of the thermal head 5 (in the direction L shown in FIG. 2).

In the glass layer 21 having the above-described configuration, radiation of heat attributable to thermal energy generated by the heat generating part 22a can be suppressed because the groove 26 prevents the heat from being conducted throughout the layer by taking advantage of the fact that the thermal conductivity of air is lower than that of glass. Further, when the coloring materials are thermally transferred onto the printing paper 3, thermal energy accumulated in the glass layer 21 allows the coloring materials to be quickly heated to a sublimating temperature with low electric power. As thus described, at the glass layer 21, the radiation of heat attributable to thermal energy generated by the heat generating part 22a can be suppressed, and the coloring materials can be heated quickly to a sublimating temperature with low electric power. Therefore, the thermal head 5 can be provided with an improved thermal efficiency. Further, the groove 26 provided on the glass layer 21 reduces the thickness of the layer and consequently reduces the amount of heat accumulated therein. The radiation of heat from the layer is therefore facilitated, and the temperature of the layer can be quickly decreased when no heat is generated by the heat generating part 22a. Therefore, the thermal head 5 can be provided with a high response. As thus described, the thermal efficiency and response of the thermal head 5 can be improved by providing the groove 26 on the glass layer 21. As a result, since the thermal head 5 has a high response, an image or character can be printed with high quality at a high speed, and a low power consumption without problems such as image blurring.

A heat generating resistor 22 provided on the glass layer 21 is formed as shown in FIG. 3. The heat generating resistor 22 is formed from a material having high resistance and anti-heat properties, such as Ta—N or Ta—SiO₂. Heat is generated by a heat generating part 22a of the heat generating resistor 22 which is exposed between a pair of electrodes 23a, 23b. A plurality of such heat generating parts 22a is provided side by side substantially in the form of a straight line extending in the longitudinal direction of the thermal head 5 (in the direction L shown in FIG. 2). The heat generating resistors 22 are patterned on the glass layer 21 using photolithography.

The pair of electrodes 23a, 23b provided on both sides of each heat generating resistor 22 are separated from each other with the heat generating part 22a interposed between them. The pair of electrodes 23a, 23b are formed from a material having high electrical conductivity, such as aluminum, gold, or copper. Referring to the pair of electrodes 23a, 23b more specifically, the pair includes a common electrode 23a that is electrically connected to all heat generating parts 22a and an individual electrode 23b that is electrically connected to the respective individual heat generating part 22a.

As shown in FIG. 3, the common electrode 23a electrically connects a power supply (not shown) and all heat generating parts 22a through the flexible substrate 17 for power supply to supply a current to the heat generating parts 22a. The common electrode 23a has a greater surface area because it is connected to all heat generating parts 22a. An individual electrode 23b is provided at each heat generating part 22a and is electrically connected to the rigid substrate 16 having the control circuit for controlling the driving of the heat generating part 22a through the flexible substrate 18 for signaling. Using the common electrode 23a and the individual electrodes 23b, the control circuit for controlling the driving of the heat generating parts 22a provided on the rigid substrate 16 causes a current to flow through selected heat generating parts 22a to generate heat at the heat generating parts 22a.

The pair of electrodes 23a, 23b provided at a heat generating resistor 22 may be connected to the rigid substrate 16 by using wire bonding instead of the flexible substrate.

The resistor protecting layer 24 provided at the outer extremity of the thermal head 5 covers the heat generating parts 22a and the neighborhood of the heat generating parts 22a to protect the heat generating parts 22a and the electrodes 23a and 23b in the neighborhood of the heat generating parts 22a from friction generated when the ink ribbon 7 contacts the thermal head 5. The resistor protecting layer 24 is formed from a glass material including a metal exhibiting excellent mechanical characteristics, such as high strength and abrasion resistance, under a high temperature and excellent thermal characteristics, such as high heat resistance, thermal shock resistance, and thermal conductivity. For example, the layer is formed from SIALON, which includes silicon (Si), aluminum (Al), oxygen (O), and nitrogen (N).

The head section 14 is formed longer than the width of the printing paper 3 in the direction indicated by the arrow L in FIG. 2, and the heat generating resistors 22 are arranged even in positions beyond the width of the printing paper 3. As a result, the thermal head 5 can print a framed image having margins on both sides thereof in the width direction of the printing paper 3. The head also is capable of frameless printing wherein the printing paper 3 is used without a margin. Further, the head can cope properly with a shift of the conveying position of the printing paper 3 or an error in the size of the printing paper 3.

At a printing step, the thermal head 5 is positioned such that the head section 14 faces the platen roller 6 with the ink ribbon 7 interposed between them. When the printing paper 3 and the ink ribbon 7 are conveyed in a direction orthogonal to the longitudinal direction of the head section 14, the heat generating resistors 22 of the thermal head 5 heat the ink ribbon 7 to thermally transfer the yellow (Y), magenta (M), and cyan (C) dye layers and the laminate layer sequentially onto the printing paper 3.

The platen roller 6 facing the thermal head 5 to sandwich the printing paper 3 and the ink ribbon 7 supports the printing paper 3 in contact with the head section 14 of the thermal head 5 from the bottom side of the same. Thus, the thermal energy of the heat generating resistors 22 are transferred to the printing paper 3 to allow the dyes on the ink ribbon 7 to be thermal-transferred onto the paper reliably. The platen roller 6 is formed by using an elastic material, such as silicone rubber, foamed silicone rubber, or EPDM (Ethylene Propylene Diene Terpolymer) and is in the form of a cylinder having a width greater than the width of the printing paper 3. The platen roller 6 is pierced by a core metal 29 and is integral with the core metal 29. The core metal 29 is a cylindrical body made of a metal, and it is supported rotatably by bearing members (not shown) at both end portions thereof in the apparatus body 2.

The elastic material used for the platen roller 6 and the stiffness of the material are selected such that the printing paper 3 can be supported with a pressure sufficient to transfer heat from the head section 14 to the entire surface of the printing paper 3 uniformly and thereby to cause a thermal transfer of the dyes on the ink ribbon 7 properly. The selection is made by also taking the withstand temperature and thermal conductivity appropriate for the thermal energy generated by the head section 14 into consideration.

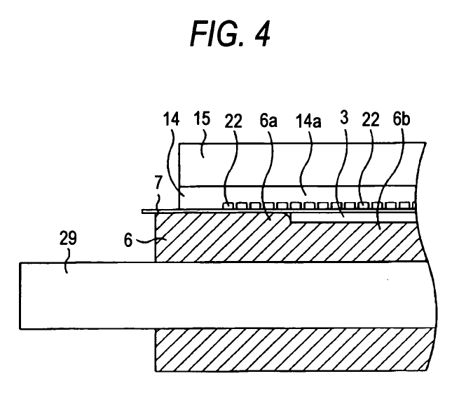

As shown in FIG. 4, the platen roller 6 is formed longer than the width of the printing paper 3 so as to allow frameless printing on the printing paper 3 and to allow a shift of the conveying position of the printing paper 3 to be properly coped with, and the roller is positioned to face the head section 14 of the thermal head 5, which is similarly formed longer than the width of the printing paper 3. Both end portions 6a, 6a of the platen roller 6 can be put in contact with both end portions 14a, 14a of the head section 14 located beyond the width of the printing paper 3 when the roller cooperates with the thermal head 5 to sandwich the printing paper 3 with the ink ribbon 7 interposed.

That is, both end portions 14a, 14a of the head section 14 of the thermal head 5 out of contact with the printing paper 3 are put in contact with both end portions 6a, 6a of the platen roller 6. Thus, the thermal energy of the heat generating resistors 22 arranged at both end portions 14a, 14a can be transferred to both end portions 6a, 6a of the platen roller 6. Therefore, the thermal head 5 can be prevented from entering a state in which the head section 14 is overheated due to the accumulation of heat from the heat generating resistors 22.

In the thermal head 5, the overheating of the head section 14 is prevented only by putting the head in contact with both end portions 6a of the platen roller 6. As a result, the amount of heat generated by the heat generating resistors 22 can be increased without employing a configuration for identifying heat generating resistors to be energized or controlling the amount of electricity supplied to particular heat generating resistors. Thus, the printing speed can be simply improved.

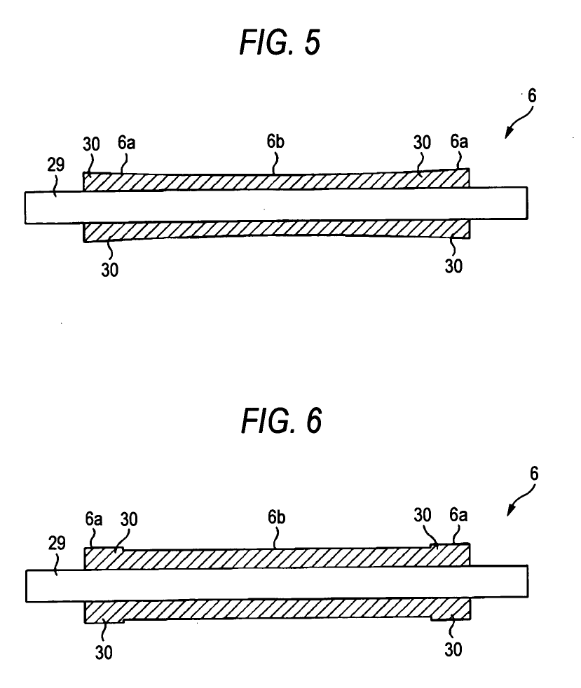

The end portions 6a, 6a can be put in contact with the end portions 14a, 14a of the head section 14 located beyond the width of the printing paper 3 as thus described by using the following configurations. For example, the platen roller 6 may have thick parts 30 formed at the end portions 6a, 6a with a thickness greater than that of an intermediate portion 6b, as shown in FIG. 5. When the thick parts 30 having a thickness greater than that of the intermediate portion 6b are formed at the end portions 6a, 6a, the platen roller 6 can contact the end portions 14a, 14a of the head section 14 located in positions beyond the width of the printing paper 3. As shown in FIG. 5, the platen roller 6 may formed alternatively with thick parts 30 whose diameter gradually increases beyond that of the intermediate portion 6b. Alternatively, steps may be formed between the thick parts 30 and the intermediate portion 6b, as shown in FIG. 6.

The platen roller 6 has a greater thickness in the end portions 6a, 6a than in the intermediate portion 6b because of the thick parts 30, and the end portions 6a, 6a are therefore relatively softer than the intermediate portion 6b. As a result, even when widthwise ends of the printing paper 3 are conveyed onto the thick parts 30 because of a leftward or rightward shift of the conveying direction of the printing paper 3 or an error in the size of the printing paper 3, any resultant difference between pressures acting on the printing paper 3 at the ends and the intermediate part of the same can be absorbed by the platen roller 6. Thus, it is possible to prevent irregularities in printing attributable to differences between pressures at which the printing paper contacts the head section 14.

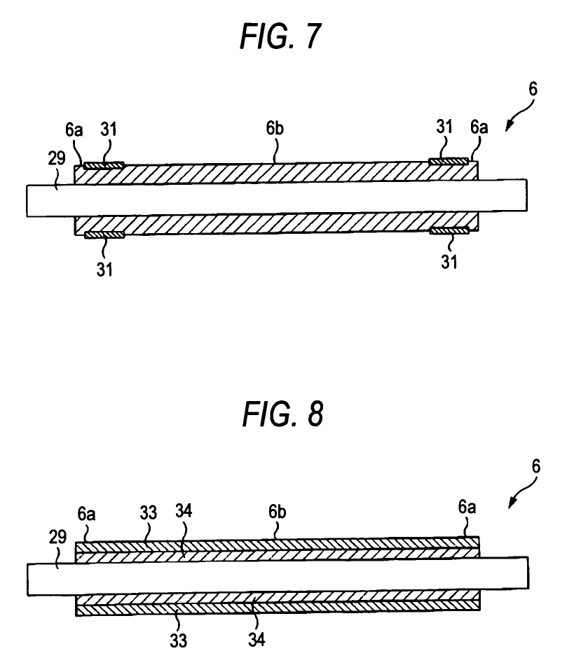

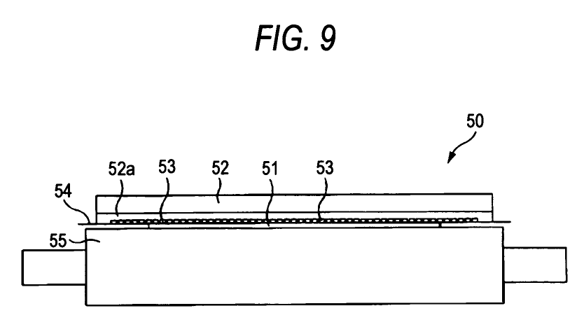

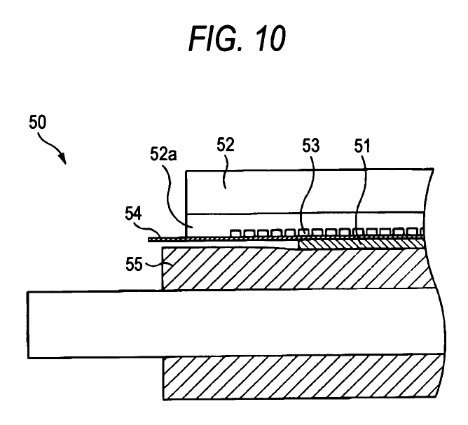

As shown in FIG. 7, the platen roller 6 may include spacer members 31 provided at the end portions 6a, 6a. Thus, the thickness of the end portions 6a, 6a is made greater than that of the intermediate portion 6b, and the end portions can be put in contact with the end portions 14a, 14a of the head section 14. The spacer members 31 are elastic members made of rubber or the like. The spacer members have a cylindrical or elongate shape having an inner diameter substantially equal to the outer diameter of the platen roller 6. The spacers are mounted on the end portions 6a, 6a by bonding or winding them to or around the end portions. By providing the spacer members 31 on the end portions 6a, 6a, the platen roller 6 can be put in contact with the end portions 14a, 14a of the head section 14 arranged in positions beyond the width of the printing paper 3.

The end portions 6a, 6a of the platen roller 6 may be made softer than the intermediate portion 6b by forming the spacer members 31 by using a material such as sponge rubber having a stiffness lower than that of the roller main body. By forming the end portions 6a, 6a softer than the intermediate portion 6b, even when widthwise ends of the printing paper 3 are conveyed onto the spacer members 31 because of a leftward or rightward shift of the conveying direction of the printing paper 3 or an error in the size of the printing paper 3, any resultant difference between pressures acting on the printing paper 3 at the ends and the intermediate part of the same can be absorbed by the platen roller 6. It is therefore possible to prevent irregularities in printing attributable to differences between pressures at which the printing paper contacts the head section 14.

Alternatively, the platen roller 6 may have an outer layer part 33 having a low stiffness and an inner layer part 34 having a relatively higher stiffness, as shown in FIG. 8, to allow the end portions 6a, 6a to contact the end portions 14a, 14a of the head section 14. For example, the outer layer part 33 having relatively low stiffness is a cylindrical body formed using sponge rubber, and the inner layer part 34 having relatively high stiffness is a cylindrical body formed using an elastic material, such as rubber, having a stiffness higher than that of the outer layer part 33. By providing such an inner layer part 34 having high stiffness, the platen roller 6 can be put in contact with the end portions 14a, 14a of the head section 14 located in positions beyond the width of the printing paper 3 by using the elastic material having lower stiffness, and irregularities in printing attributable to an insufficient pressure at the intermediate portion 6b where the printing paper 3 is supported can occur.

Specifically, when the platen roller 6 is formed only from a material having low stiffness, such as sponge rubber, the pressure applied by the platen roller 6 in the conveying direction of the printing paper 3 can become unstable as the platen roller 6 rotates in conjunction with the conveyance of the printing paper 3 while the printing paper 3 is sandwiched between the head section 14 of the thermal head 5 and the platen roller 6. Thus, irregularities in printing can occur. The reason for the problem is as follows. When the platen roller 6 is formed using an elastic material having low stiffness, the pressure of the platen roller 6 for pressing the printing paper 3 against the head section 14 becomes low and unstable when viewed in the conveying direction of the printing paper 3. As a result, the thermal energy of the heat generating resistors 22 is not transferred to the entire printing paper 3 uniformly. Under this circumstance, the platen roller 6 is provided with the inner layer part 34 having higher stiffness between the core metal 29 and the outer layer part 33 having low stiffness to eliminate the shortage of the pressure applied to the printing paper 3 at the intermediate portion 6b, whereby a stable printing quality is achieved.

A printing process performed by the printer apparatus 1 will now be described. When the paper tray containing sheets of printing paper 3 cut in a predetermined size is mounted in the printer apparatus 1, the leading edge of a sheet of printing paper 3 is pulled out by a sheet feeding roller of the conveying mechanism 4. The printing paper 3 is conveyed in the direction of the arrow a in FIG. 1 under guidance provided by a guide roller that is not shown, and the paper is thus passed to the pinch roller 11 and the capstan roller 12. When the process proceeds to a printing operation, the printer apparatus 1 sandwiches the printing paper 3 and the ink ribbon 7 with the thermal head 5 and the platen roller 6. At this time, the end portions 14a, 14a of the head section 14 of the thermal head 5 and the end portions 6a, 6a of the platen roller 6 extend up to positions beyond the width of the printing paper 3, and the end portions 6a, 6a of the platen roller 6 are in contact with the end portions 14a, 14a of the head section 14, as shown in FIG. 4.

Then, the pinch roller 11 and the capstan roller 12 are rotated in synchronism with the spools 8, 8 of the ink ribbon cartridge to convey the printing paper 3 and the ink ribbon 7 in the direction of the arrow a in FIG. 1 or in the direction opposite to the arrow a. At the same time, the dyes on the ink ribbon 7 are thermal-transferred onto the printing paper 3 to print an image on the same using thermal energy generated by energizing the heat generating resistors 22 of the head section 14. At this time, the head section 14 of the printer apparatus 1 is prevented from becoming overheated because heat generated by the heat generating resistors 22 at the end portions 14a, 14a of the head section 14 located beyond the width of the printing paper 3 is radiated by being conducted to the end portions 6a, 6a of the platen roller 6. It is therefore possible to prevent printing defects attributable to changes in the resistance of the heat generating resistors 22 and cracking, distortion, or melting of the glass layer.

The dyes on the ink ribbon 7 may be thermal-transferred onto the end portions 6a, 6a of the platen roller 6 because they are in contact with the head section 14. However, the dyes transferred to the platen roller 6 will not be deposited on the bottom surface of the printing paper 3.

The printing process is performed by thermally transferring the yellow (Y), magenta (M), and cyan (C) dye layers and the laminate layer formed on the ink ribbon 7 onto the printing paper 3. Specifically, each time the printing paper 3 is conveyed in the direction of the arrow a or the direction opposite to the arrow a, one of the dye layers or the laminate layer is thermal-transferred. When the first thermal transfer is completed, the paper is conveyed in the direction opposite to the direction at the time of the thermal transfer. The paper is then conveyed again in the direction of the arrow a or the direction opposite to the arrow a to perform the next cycle of thermal transfer onto the same region. Thus, the printing paper 3 is reciprocated four times across the thermal head 5 to print one image. Each time the thermal transfer of one dye layer is completed, the ink ribbon 7 is wound by the spool 8, which allows the next dye layer or the laminate layer to be pulled out and put in contact with the printing paper 3.

When the laminate layer is thermal-transferred onto the printing paper 3 to complete printing, the printing paper 3 is conveyed in the direction of the arrow a to be discharged from the apparatus body 2. The printer apparatus 1 enters the next printing process by conveying the next sheet of printing paper 3 with the pinch roller 11 and the capstan roller 12, feeding the ink ribbon 7 up to the position of a yellow (Y) dye layer. Then, a thermal transfer is performed by the thermal head 5 based on image data.

While a printer apparatus according to the embodiment of the invention has been described above, the invention may be applied to any printer apparatus of the sublimation type, fusion type, or heat sensitive type, in which a thermal head is used, in addition to the sublimation type thermal head printer apparatus as described above.

When sheets of printing paper 3 having different sizes are contained in the printer apparatus 1 to allow them to be printed according to operations of a user, the thermal head 5 and the platen roller 6 are extended to positions beyond the width of the sheets of printing paper having the largest size among the printable sheets of paper. At a printing process, the head and the platen roller are put in contact with each other in regions beyond the width of any of the sheets of printing paper.

In addition to a printer apparatus for printing sheets of paper cut in a predetermined size in advance, the invention may be applied to a printer apparatus which contains a roll of elongate printing paper in the body of the same and which pulls out the printing paper from the roll to print an image on the same and discharges the paper after cutting it into a predetermined size.

It should be understood by those skilled in the art that various modifications, combinations, subcombinations and alterations may occur depending on design requirements and other factors insofar as they are within the scope of the appended claims or the equivalents thereof.

1. A printer apparatus comprising:
a thermal head having heat generating elements arranged in the form of a line extending longer than the width of a printing medium in the width direction of the printing medium substantially orthogonal to the conveying direction thereof; and
a platen disposed opposite to the thermal head with a conveying path for the printing medium interposed between them so as to cooperate with the thermal head to sandwich the printing medium beyond the width of the printing medium with an ink ribbon interposed,
the platen being put in contact with an end portion of the thermal head located beyond the width of the printing medium.

2. A printer apparatus according to claim 1, wherein an end portion of the platen contacting the end portion of the thermal head is formed softer than an intermediate portion.

3. A printer apparatus according to claim 1, wherein the platen has an elastic member provided at an end portion thereof contacting the end portion of the thermal head.

4. A printer apparatus according to claim 3, wherein the elastic member is softer than an intermediate portion of the platen.

5. A printer apparatus according to claim 1, wherein the platen is formed with a thickness which is greater in an end portion thereof contacting the end portion of the thermal head than in an intermediate portion.

6. A printer apparatus according to claim 1, wherein the platen includes an outer layer part which is put in contact with the thermal head and an inner layer part provided under the outer layer part; and
the outer layer part is formed softer than the inner layer part.

7. A printer apparatus according to claim 1, wherein the platen comprises a roller member disposed so as to longitudinally extend in the width direction and cooperates with the thermal head to sandwich the printing medium and the ink ribbon.

8. A printer apparatus according to any of claim 2, wherein the platen comprises a roller member disposed so as to longitudinally extend in the width direction and cooperates with the thermal head to sandwich the printing medium and the ink ribbon.

9. A printer apparatus according to any of claim 3, wherein the platen comprises a roller member disposed so as to longitudinally extend in the width direction and cooperates with the thermal head to sandwich the printing medium and the ink ribbon.

10. A printer apparatus according to any of claim 4, wherein the platen comprises a roller member disposed so as to longitudinally extend in the width direction and cooperates with the thermal head to sandwich the printing medium and the ink ribbon.

11. A printer apparatus according to any of claim 5, wherein the platen comprises a roller member disposed so as to longitudinally extend in the width direction and cooperates with the thermal head to sandwich the printing medium and the ink ribbon.

12. A printer apparatus according to any of claim 6, wherein the platen comprises a roller member disposed so as to longitudinally extend in the width direction and cooperates with the thermal head to sandwich the printing medium and the ink ribbon.
